(19) United States
(12) Patent Application Publication
(10) Pub. No.: US 2020/0137336 A1
(43) Pub. Date: Apr. 30, 2020

(54) INTERLACE IMAGE SENSOR FOR LOW-LIGHT-LEVEL IMAGING

(71) Applicant: BAE Systems Information and Electronic Systems Integration Inc., Nashua, NH (US)

(72) Inventors: Christopher R. Adams, Saratoga, CA (US); R. Daniel McGrath, Lexington, MA (US)

(73) Assignee: BAE Systems Information and Electronic Systems Integration Inc., Nashua, NH (US)

(21) Appl. No.: 16/175,359

(22) Filed: Oct. 30, 2018

(51) Int. Cl. H04N 5/378; H04N 7/18

(52) U.S. Cl. CPC H04N 5/378; H04N 7/183

(57) ABSTRACT

A low light level imaging apparatus comprising an image sensor having a plurality of pixels, where the image sensor is configured to readout in an interlaced manner to a display that allows for real-time viewing of image sensor data by a user or users, where some users may be remote from the low light level imaging apparatus, in the form of a video stream.

### FIELD

The disclosure relates to imaging, and more particularly, to apparatuses and methods for low-light-level imaging.

### BACKGROUND

Digital detection of visual and infrared (IR) images is a very widely used technology, having applications ranging from consumer-oriented cameras and video apparatuses to law enforcement and military equipment. At the heart of all digital imaging systems, which may be referred to generally as Solid State Area Array Imaging Devices (SSAAIDs), is the Focal Plane Array (FPA), which is a two-dimensional array of elements upon which an image is focused, whereby each of the FPA elements or “pixels” develops an analog output “signal charge” that is proportional to the intensity of the electromagnetic radiation that is impinging on it over a given interval of time. This signal charge can then be measured and used to produce an image.

In night vision imaging applications involving the capture and subsequent display to an observer of a moving low-light-level scene, it has been found that the human brain synthesizes multiple images to better interpret the information. More specifically, in such conditions the human visual system integrates, or combines the data communicated by, a relatively small number of events, which are scattered over areas of a given frame and also over multiple frames, to accurately locate and identify moving objects. This occurs primarily when the photon flux, or the number of photons per second per unit area, at an image sensor is on the level of or less than the pixel density, the number of pixels per unit area. This is a condition that is often present during low-light-level imaging, as used in night vision and similar systems, and is herein referred to as a state of low photon flux. Suffice it to say that low-light-level imaging inherently involves a tight interaction between images in a video stream conveyed to the user (also herein referred to as the observer) and the brain processing those images to obtain actionable information, for example to allow a user to detect obstacles, make friend-or-foe decisions, etc.

For many years, image intensifier tubes were used for night vision purposes. Such devices function by directing photons onto a photocathode that converts the photons to electrons, which are then amplified before being converted back to photons for viewing, often by impacting the electrons against a phosphor screen. Although effective, image intensifier tubes have a number of issues, including bulkiness, parallax and distortion, lack of robustness (e.g. they will burn out if pointed in the direction of a sufficiently bright light source, such as the sun or a laser), and an inability to continue to function in relatively bright environments (i.e. dark/indoor to outdoor/daylight transitions), forcing an observer to rotate the device into and out of view as the ambient light level changes. Furthermore, as such devices utilize direct viewing of the generated image by the observer, i.e. they do not store and redisplay the image presented to the user, there is no possibility of sharing the observer's view with a third party.

Due to these issues, night vision systems predominantly utilize solid-state, digital, high-framerate, progressive-scan night vision imagers. For reasons that are not totally understood, such imagers tend to lead to user discomfort, even after periods of limited use. This phenomenon can be especially acute where the observer is moving. In many of these cases, the discomfort, which may include intense nausea and vomiting, is severe enough to prevent the observer from operating in an efficient manner.

What is needed, therefore, is a relatively compact apparatus and method that allows for the low-light-level images to be presented to an observer that does not result in discomfort thereto and that allows the image to be shared with third parties while conveying the same amount of or more information to the observer, compared to prior art high-framerate devices and methods.

### SUMMARY

The present disclosure provides a way to provide for timely updating of a pixel array, without making use of the brute force approach of using high frame rates, while retaining many of its benefits. Embodiments described herein also consume less power than prior art devices that achieve similar performance. Embodiments in accordance with the present disclosure also mitigate the discomfort associated with prior art devices.

Such gains are realized by configuring an FPA configured for use in a night vision or low light level system to readout in an interlaced manner. Said another way, in embodiments, the pixels comprising the FPA are read out as a sequence of multiple inter-pixelated subframes. In embodiments, each subframe is slightly displaced from the others so that, at the end of each subframe repeat, the data from the whole array has been read out.

Embodiments, relative to conventional devices, lengthen exposure time (i.e. frame time, time to collect light), thereby maximizing SNR while providing a rapid update rate and delivering high resolution. Where the pixel array is kept relatively stationary, the full resolution benefit of these techniques is realized, while, during periods where the pixel array is mobile, a relatively high update rate is maintained. In short, embodiments maximize resolution and update (frame) rate while maximizing the Signal-to-Noise Ratio (SNR), given a finite amount of light to capture.

In one exemplary embodiment, the low level imaging apparatus is a night vision goggle used by military personnel deployed in a hostile environment. Such situations often require considerable movement, unaided by visible light sources, requiring the use of such a visual aid. However, if the user becomes disoriented or is otherwise not capable of full engagement, the results could be very serious, possibly resulting in the death of the user. The interlaced images provided by the present system and methods of operation thereof, by reducing discomfort, allow the user to remain fully engaged, even during periods of extended usage of the device.

One embodiment of the present disclosure provides a low light level imaging apparatus comprising: an image sensor comprising a plurality of pixels, wherein the image sensor is configured for operation at low photon flux, wherein the image sensor is further configured to readout the pixels in a non-consecutive pattern, and wherein each frame read out of the image sensor comprises multiple fields.

Another embodiment of the present disclosure provides such a low light level imaging apparatus further comprising a display configured to receive and display images produced by the image sensor.

A further embodiment of the present disclosure provides such a low light level imaging apparatus wherein the display is configured to convert the images to a progressive-scan format prior to displaying the images.

Yet another embodiment of the present disclosure provides such a low light level imaging apparatus wherein the display is configured to reproduce the images in an interlaced manner.

A yet further embodiment of the present disclosure provides such a low light level imaging apparatus wherein the image sensor is configured to output images substantially continuously.

Still another embodiment of the present disclosure provides such a low light level imaging apparatus wherein the low light level imaging apparatus is configured to transmit images captured by the image sensor to a remote device for storage and/or viewing.

A still further embodiment of the present disclosure provides such a low light level imaging apparatus wherein the image sensor is read out in a pattern of row-wise blocks, with one pixel from each block read out as its block is addressed.

Even another embodiment of the present disclosure provides such a low light level imaging apparatus wherein the pixel from each block that is read out as the block is addressed is in the same position in each block.

An even further embodiment of the present disclosure provides such a low light level imaging apparatus wherein the image sensor is read out by row, beginning with all odd-numbered rows in a first refresh cycle and ending with all even-numbered rows in a second refresh cycle.

A still even another embodiment of the present disclosure provides such a low light level imaging apparatus wherein the image sensor is read out by row, beginning with all even-numbered rows in a first refresh cycle and ending with all odd-numbered rows in a second refresh cycle.

One embodiment of the present disclosure provides a method of avoiding user discomfort and enhancing perceived framerate while reducing bandwidth requirements during use of a low light level imaging apparatus comprising: on a low light level imaging apparatus comprising: an image sensor comprising a plurality of pixels, wherein the image sensor is configured for operation at low photon flux, and wherein the pixels are refreshed in no fewer than two refresh cycles, reading out the pixels in a non-consecutive pattern, thereby producing data corresponding to an image generated by the image sensor; conveying the data to a display; and reproducing the image on the display using the data.

Another embodiment of the present disclosure provides such a method of avoiding user discomfort and enhancing perceived framerate while reducing bandwidth requirements during use of a low light level imaging apparatus wherein the method is rapidly repeated, thereby producing a video comprising a plurality of images on the display.

A further embodiment of the present disclosure provides such a method of avoiding user discomfort and enhancing perceived framerate while reducing bandwidth requirements during use of a low light level imaging apparatus wherein the display is configured to the display is configured to convert the images to a progressive-scan format prior to displaying the images.

Yet another embodiment of the present disclosure provides such a method of avoiding user discomfort and enhancing perceived framerate while reducing bandwidth requirements during use of a low light level imaging apparatus wherein the display is configured to reproduce the images in an interlaced manner.

A yet further embodiment of the present disclosure provides such a method of avoiding user discomfort and enhancing perceived framerate while reducing bandwidth requirements during use of a low light level imaging apparatus further comprising transmitting the information corresponding to an image generated by the image sensor to a remote device for storage and/or viewing

Still another embodiment of the present disclosure provides such a method of avoiding user discomfort and enhancing perceived framerate while reducing bandwidth requirements during use of a low light level imaging apparatus wherein the image sensor is read out in a pattern of row-wise blocks, with one member of each block read out as its block is addressed.

A still further embodiment of the present disclosure provides such a method of avoiding user discomfort and enhancing perceived framerate while reducing bandwidth requirements during use of a low light level imaging apparatus wherein the member of each block that is read out as the block is addressed is in the same position in each block.

Even another embodiment of the present disclosure provides such a method of avoiding user discomfort and enhancing perceived framerate while reducing bandwidth requirements during use of a low light level imaging apparatus wherein the image sensor is read out by row, beginning with all odd-numbered rows in a first refresh cycle and ending with all even-numbered rows in a second refresh cycle.

An even further embodiment of the present disclosure provides such a method of avoiding user discomfort and enhancing perceived framerate while reducing bandwidth requirements during use of a low light level imaging apparatus wherein the image sensor is read out by row, beginning with all even-numbered rows in a first refresh cycle and ending with all odd-numbered rows in a second refresh cycle.

One embodiment of the present disclosure provides a head-mounted low light level imaging apparatus, the head-mounted low light level imaging apparatus comprising: a night vision apparatus comprising: an image sensor comprising a plurality of pixels; and a display configured to receive and display images produced by the image sensor, wherein the image sensor is configured for operation at low photon flux, wherein the image sensor is further configured to readout the pixels in a non-consecutive pattern, wherein all pixels are refreshed in no fewer than two refresh cycles, wherein the image sensor is configured to output images substantially continuously, creating a video stream, wherein persistence of an image on the display is user-adjustable during use, and wherein the low light level imaging apparatus is configured to transmit images captured by the image sensor to a remote device for storage and/or viewing.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a schematic showing a prior art pixel array that operates using a row-wise sequential readout;

FIG. 2 is a schematic showing a pixel array that operates using an interlaced readout, in this embodiment interlacing adjacent rows, beginning with odd-numbered rows, in accordance with embodiments of the present disclosure;

FIG. 3 is a schematic showing a pixel array that operates using an interlaced readout, in this embodiment interlacing adjacent rows, beginning with even-numbered rows, in accordance with embodiments of the present disclosure;

FIG. 4 is a schematic showing a pixel array that operates using an interlaced readout, in this embodiment interlacing pixels from adjacent box-shaped groups of pixels, in accordance with embodiments of the present disclosure;

FIG. 5 is a schematic showing a pixel array that operates using an interlaced readout, in this embodiment interlacing using a pseudo-random pattern in which a pseudo-random pixel is selected from adjacent boxes of pixels, each box comprising the same numbers of pixels, in accordance with embodiments of the present disclosure; and

FIG. 6 is a flowchart describing a method of interlacing the readout of a pixel array, in accordance with embodiments of the present disclosure.

### DETAILED DESCRIPTION

As a preliminary matter, a field is an image that contains only a portion of the image information needed to render a complete image on a given display, wherein the amount of image information that comprises the field compared to the total amount of information required to display a complete image on the display is equal to the number of passes required to update the various groupings of pixels 106. Persistence of vision, or persistence built into a display, allows the eye to perceive the multiple fields as a continuous image.

Interlacing is the technique of using multiple fields to create a frame, or a complete image. For example, one field may contain information sufficient to populate all odd-numbered rows 104 in the image while another contains the information needed to populate all even-numbered lines.

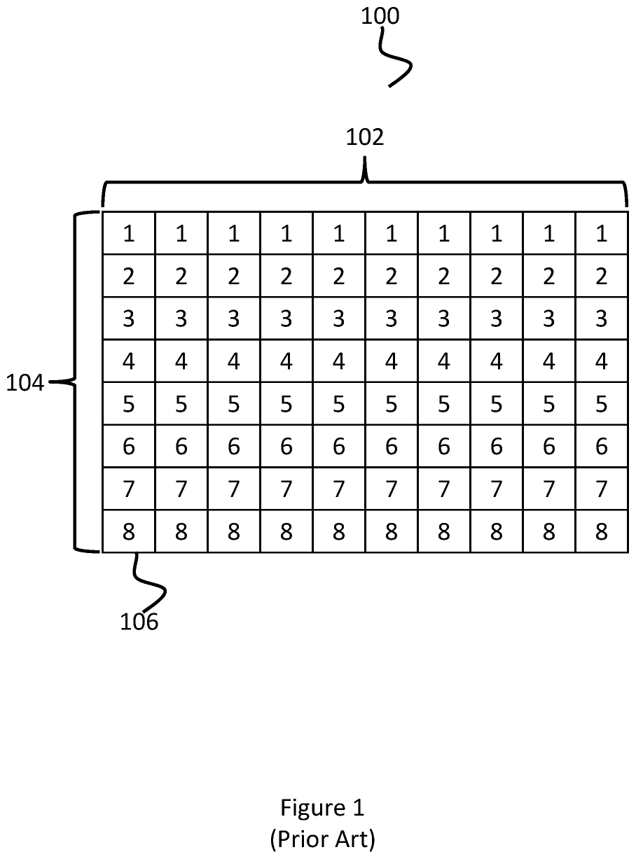

The prior art pixel array 100 described schematically in FIG. 1, which is 10 pixels 106 wide and 8 pixels tall, but could be of any size, is configured perform readout in a row-wise, sequential manner, updating each pixel 106 during each refresh cycle. The numbering is used to indicate the order in which individual pixels 106 are updated. Most such pixel arrays 100 used in digital night vision devices operate at a high frame rate (e.g. >60 frames per second) to eliminate or reduce perceived latency.

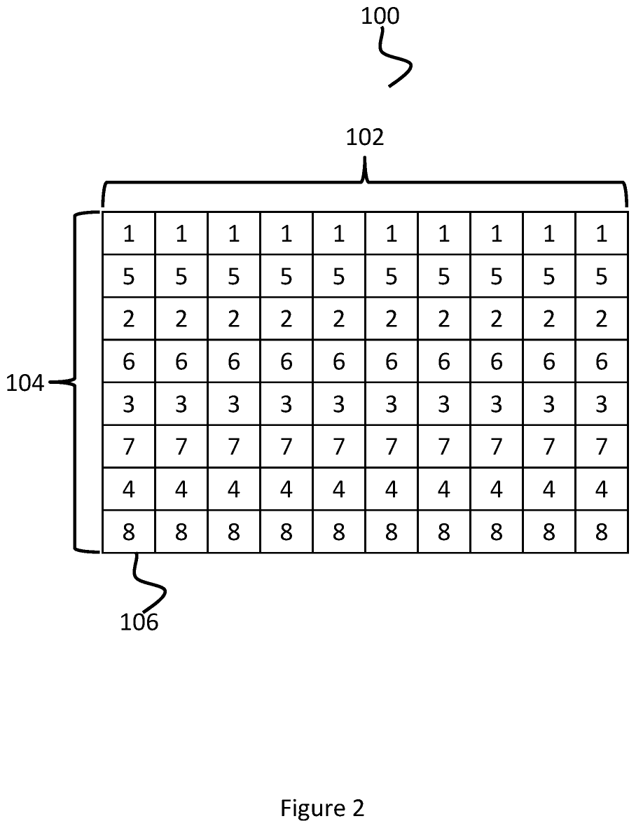

FIGS. 2-5 show pixel arrays 100 configured to perform readout in an interlaced manner, i.e. non-consecutively (random, all odd-rows followed by all even-numbered rows, a predefined pixel 106 from a plurality of pixel 106 groupings followed by each other pixel 106 in those groupings, a random pixel 106 from a plurality of pixel 106 groupings followed by a different random pixel 106 in each of those groupings until all pixels 106 are read out, etc.) and over multiple frames (i.e. a single frame comprises multiple fields), in accordance with embodiments of the present disclosure. As in FIG. 1, numbering is used to indicate the order in which individual pixels 106 are updated, with same-numbered pixels 106 being refreshed in a given refresh cycle of the pixel array 100. Although these pixel arrays 100 are shown as having 10 columns and 8 rows, they could be of any size without departing from the teachings provided herein; the size used in the figures was chosen merely for simplicity of presentation.

The advantages of the embodiments depicted in FIGS. 2-5 are numerous. One benefit is that, given that each subframe provides current information, the data rate for readout in such embodiments can be reduced by a factor equal to the number of subframes (i.e. reducing the readout frame rate) while maintaining the update rate of the image information. For example, if subframes are mapped so that individual pixels 106 map to create 2×2 tiling in the pixel array 100, a 90 frame per second update rate is obtained by reading subframes of ¼ of the pixels each in series at the 90 frame per second rate to reduce the data rate by a factor of four (4). The resulting slower data rate relaxes circuit requirements on the image sensor and reduces power requirements on the image sensor and on the overall system.

Another advantage of embodiments of the present disclosure is that, given the slower read time per pixel 106 in each subframe, each pixel integrates charge for its subframe for a longer time. With Complementary Metal Oxide Semiconductor (CMOS) image sensors in particular, which are used in low light level imaging devices, the longer the time the capture the photons from the scene, the higher the signal and the better the Signal-to-Noise Ratio (SNR) and the higher the SNR, the clearer the image obtained. The time allowed for photon capture by an image sensor, e.g. a pixel array 100, is the inverse of the frame rate For example, for a 2×2 tiling in the pixel array 100, each pixel 106 could integrate 4× longer, or for 1/15 second for a 90 frame per second operation. Said another way, a slower framerate results in an increase in the number of photons incident on a given pixel 106 during an integration period, with a halving of the frame rate resulting in a doubling of the photons incident on a given pixel 106 during an integration period, resulting in enhanced night-vision capabilities.

Even another advantage of embodiments of the present disclosure is that, given that the eye integrates over multiple pixels 106 to create the extended objects required to render displayed images actionable in low-light-level imaging, the use of subsampled subarrays does not degrade the resolution required for human image processing in this environment.

Still even another advantage of embodiments of the present disclosure is that, since noise increases proportionally with the square root of the framerate and only updating a portion of the pixels 106 in a given refresh cycle is equivalent to operating the pixel array 100 at a reduced framerate that is equivalent to the number of cycles that it would take to update each pixel 106 of the pixel array 100, noise is substantially decreased, as are power requirements.

Now referring specifically to FIG. 2, a pixel array 100 comprising columns of pixels 102 and rows of pixels 104 is shown. The pixel array 102 shown in FIG. 2 reads out the first row of pixels 104 followed by every other odd-numbered row of pixels 104, until all odd-numbered rows 104 of the pixel array 100 are readout. Subsequently, the rows 104 adjacent the odd-numbered rows 104, the even-numbered rows 104, are readout in a subsequent pass, in accordance with embodiments of the present disclosure.

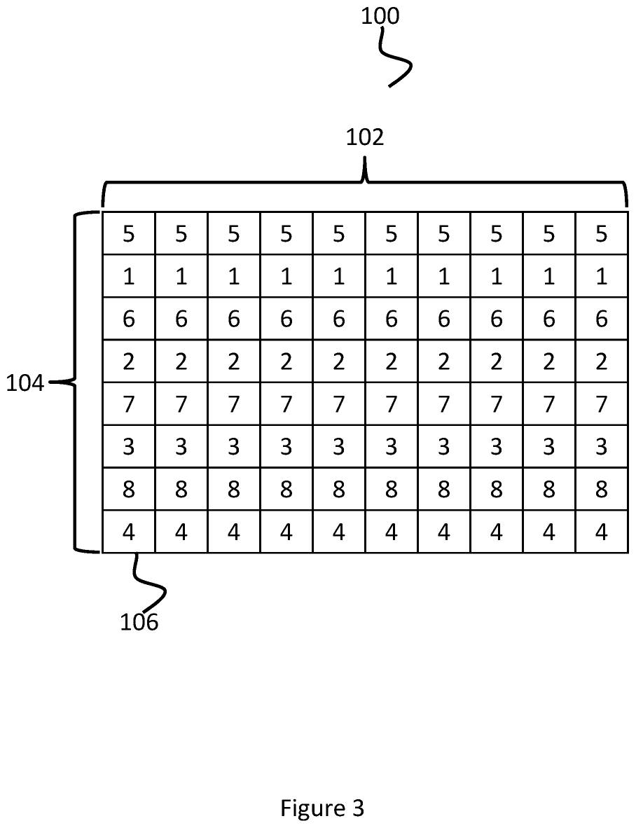

Now referring specifically to FIG. 3, a pixel array 100 comprising columns of pixels 102 and rows of pixels 104 is shown. The pixel array 102 shown in FIG. 3 reads out the second row of pixels 104 followed by every other even-numbered row of pixels 104, until all even-numbered rows 104 of the pixel array 100 are readout. Subsequently, the rows 104 adjacent the even-numbered rows 104, the odd-numbered rows 104, are readout in a subsequent pass, in accordance with embodiments of the present disclosure.

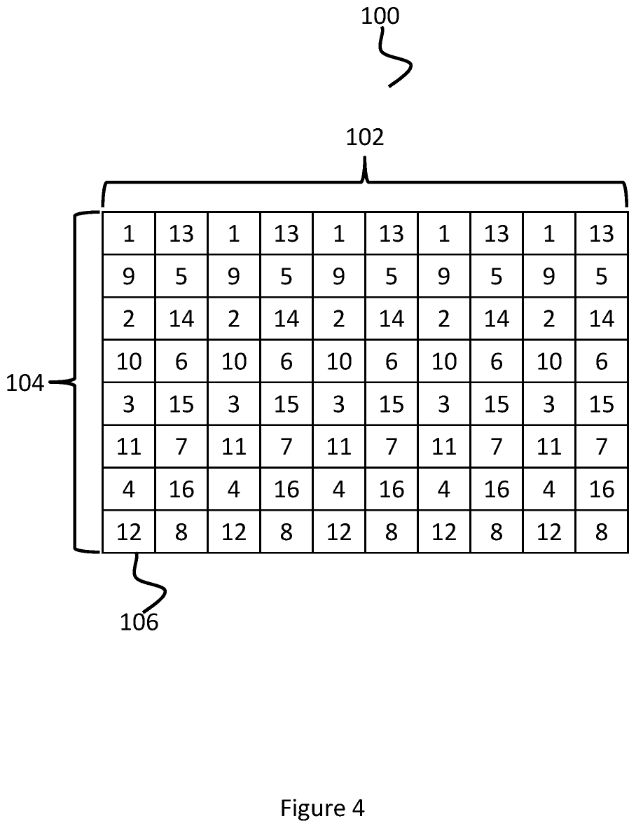

Now referring specifically to FIG. 4, a pixel array 100 comprising columns of pixels 102 and rows of pixels 104 is shown. The pixel array 102 shown in FIG. 4 is configured to divide the pixel array 100 into square boxes and to readout the top-left pixel 106 in each box first, followed by the bottom-right pixel 106 in each box, followed by the bottom-left pixel 106 in each box, and ending with the top-right pixel 106 in each box, in accordance with embodiments of the present disclosure.

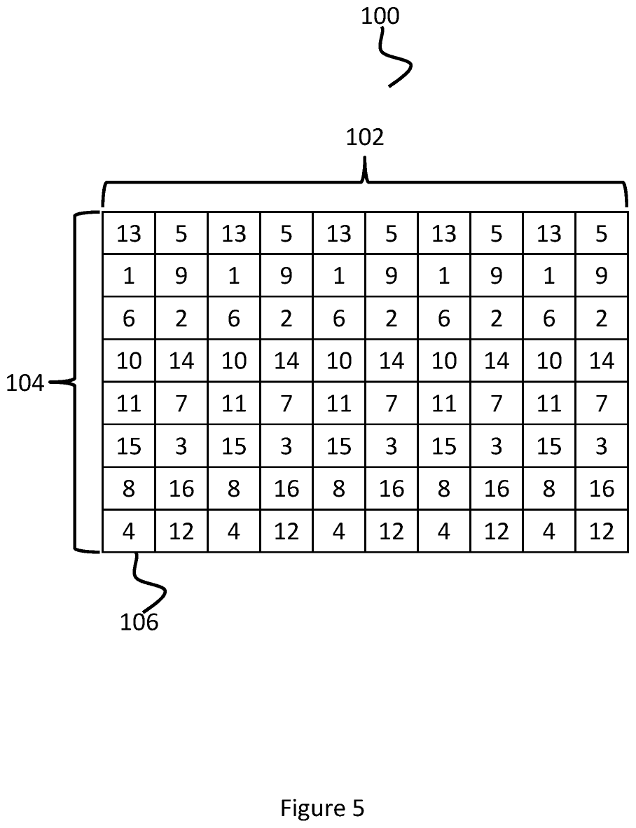

Now referring specifically to FIG. 5, a pixel array 100 comprising columns of pixels 102 and rows of pixels 104 is shown. The pixel array 102 shown in FIG. 5 is, like FIG. 4, configured to divide the pixel array 100 into square boxes, but readout of pixels 106 is pseudo-random within each box, in accordance with embodiments of the present disclosure.

The interlacing patterns described in FIGS. 2-5 are merely exemplary and other interlacing patterns may be used without departing from the teachings of the present disclosure.

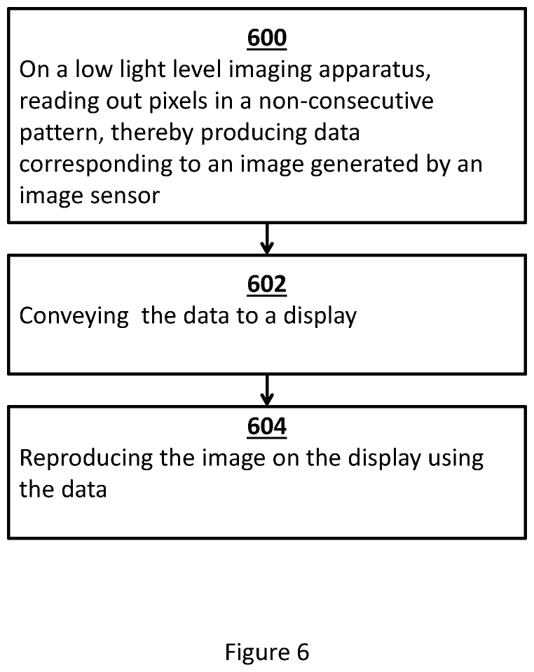

Now referring to FIG. 6, a flowchart describing a method of interlacing the readout of a pixel array, in accordance with embodiments of the present disclosure, is described. The method entails, on a low light level imaging apparatus, reading out pixels in a non-consecutive pattern, thereby producing data corresponding to an image generated by an image sensor 600. This step is followed by conveying the data to a display 602 and then reproducing the image on the display using the data 604.

In embodiments, a display used to display data generated by the pixel array 100 is configured to persist images thereon. In embodiments, the duration of this persistence is adjustable.

In embodiments, the display is a screen-type display, such as a computer screen, television screen, projector, or other visual display unit, including head mounted displays, heads-up displays, augmented and virtual reality displays, all of which includes goggles and glasses.

In embodiments, a single image displayed to a user results from the combination of a plurality of fields.

Embodiments of the present disclosure allow for larger format size pixel arrays 106, as compared to the prior art.

Embodiments could also be used in a micro bolometer Readout Integrated Circuit (ROIC) to increase the perceived frame rate to the maximum extent (i.e. to the limit of the time constant).

Even further embodiments could also be used to reduce the bandwidth requirements of large format, high frame rate cameras.

The foregoing description of the embodiments of the disclosure has been presented for the purposes of illustration and description. It is not intended to be exhaustive or to limit the disclosure to the precise form disclosed. Many modifications and variations are possible in light of this disclosure. It is intended that the scope of the disclosure be limited not by this detailed description, but rather by the claims appended hereto.

What is claimed is:

1. A low light level imaging apparatus comprising:
an image sensor comprising a plurality of pixels,
wherein said image sensor is configured for operation at low photon flux,
wherein said image sensor is further configured to readout said pixels in a non-consecutive pattern, and
wherein each frame read out of the image sensor comprises multiple fields.

2. The low light level imaging apparatus of claim 1 further comprising a display configured to receive and display images produced by said image sensor.

3. The low light level imaging apparatus of claim 2 wherein said display is configured to convert said images to a progressive-scan format prior to displaying said images.

4. The low light level imaging apparatus of claim 2 wherein said display is configured to reproduce said images in an interlaced manner.

5. The low light level imaging apparatus of claim 1 wherein said image sensor is configured to output images substantially continuously.

6. The low light level imaging apparatus of claim 1 wherein said low light level imaging apparatus is configured to transmit images captured by said image sensor to a remote device for storage and/or viewing.

7. The low light level imaging apparatus of claim 1 wherein said image sensor is read out in a pattern of row-wise blocks, with one pixel from each block read out as its block is addressed.

8. The low light level imaging apparatus of claim 7 wherein the pixel from each block that is read out as the block is addressed is in the same position in each block.

9. The low light level imaging apparatus of claim 1 wherein said image sensor is read out by row, beginning with all odd-numbered rows in a first refresh cycle and ending with all even-numbered rows in a second refresh cycle.

10. The low light level imaging apparatus of claim 1 wherein said image sensor is read out by row, beginning with all even-numbered rows in a first refresh cycle and ending with all odd-numbered rows in a second refresh cycle.

11. A method of avoiding user discomfort and enhancing perceived framerate while reducing bandwidth requirements during use of a low light level imaging apparatus comprising:
on a low light level imaging apparatus comprising:
an image sensor comprising a plurality of pixels,
wherein said image sensor is configured for operation at low photon flux, and
wherein the pixels are refreshed in no fewer than two refresh cycles,
reading out said pixels in a non-consecutive pattern, thereby producing data corresponding to an image generated by said image sensor;
conveying said data to a display; and
reproducing said image on said display using said data.

12. The method of claim 11 wherein said method is rapidly repeated, thereby producing a video comprising a plurality of images on said display.

13. The method of claim 11 wherein said display is configured to said display is configured to convert said images to a progressive-scan format prior to displaying said images.

14. The method of claim 11 wherein said display is configured to reproduce said images in an interlaced manner.

15. The method of claim 11 further comprising transmitting said information corresponding to an image generated by said image sensor to a remote device for storage and/or viewing

16. The method of claim 11 wherein said image sensor is read out in a pattern of row-wise blocks, with one member of each block read out as its block is addressed.

17. The method of claim 16 wherein the member of each block that is read out as the block is addressed is in the same position in each block.

18. The method of claim 11 wherein said image sensor is read out by row, beginning with all odd-numbered rows in a first refresh cycle and ending with all even-numbered rows in a second refresh cycle.

19. The method of claim 11 wherein said image sensor is read out by row, beginning with all even-numbered rows in a first refresh cycle and ending with all odd-numbered rows in a second refresh cycle.

20. A head-mounted low light level imaging apparatus, the head-mounted low light level imaging apparatus comprising:
a night vision apparatus comprising:
an image sensor comprising a plurality of pixels; and
a display configured to receive and display images produced by said image sensor,
wherein said image sensor is configured for operation at low photon flux,
wherein said image sensor is further configured to readout said pixels in a non-consecutive pattern,
wherein all pixels are refreshed in no fewer than two refresh cycles,
wherein said image sensor is configured to output images substantially continuously, creating a video stream,
wherein persistence of an image on said display is user-adjustable during use, and
wherein said low light level imaging apparatus is configured to transmit images captured by said image sensor to a remote device for storage and/or viewing.
